(19) United States
(12) Patent Application Publication
(10) Pub. No.: US 2025/0046300 A1
(43) Pub. Date: Feb. 6, 2025

(54) AUTOMATIC SPEECH RECOGNITION FOR INTERACTIVE VOICE RESPONSE SYSTEMS

(71) Applicant: Zoom Video Communications, Inc., San Jose, CA (US)

(72) Inventors: Sebastian Stüker, Karlsruhe (DE); Jianfang Zhai, Hangzhou (CN); Shenquan Zhang, Hangzhou (CN)

(21) Appl. No.: 18/228,349

(22) Filed: Jul. 31, 2023

(51) Int. Cl. G10L 15/16; G10L 15/06

(52) U.S. Cl. CPC G10L 15/16; G10L 15/063

(57) ABSTRACT

One example method includes receiving an audio input from a user; determining, using a first trained model, a plurality of candidate commands; determining, using a second trained model, a recognized command from the plurality of candidate commands; and identifying a corresponding valid command in a set of valid commands based on the recognized command.

### FIELD

The present disclosure relates generally to automatic speech recognition and, more particularly to controlling an interactive voice response system with automatic speech recognition.

### BRIEF DESCRIPTION OF THE DRAWINGS

FIG. 1 shows a block diagram of an interactive voice response system (IVR);

FIG. 2 shows a block diagram of a network receiving IVR commands:

FIG. 3 shows a block diagram of a module for recognizing commands with automatic speech recognition (ASR):

FIG. 4 shows a schematic of a finite state transducer for recognizing a command with ASR:

FIG. 5 shows a flowchart of a process for executing an IVR command using ASR; and

FIG. 6 shows an example computing device suitable for use with systems and methods for ASR for IVR systems according to this disclosure.

### DETAILED DESCRIPTION

Examples are described herein in the context of automatic speech recognition (ASR) for interactive voice response (IVR) applications. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application and business-related constraints, and that these specific goals will vary from one implementation to another and from one developer to another.

IVR is a technology that allows telephone users to interact with a computer-operated telephone system through the use of voice and keypad inputs. IVR systems can respond with pre-recorded or dynamically generated audio to provide users with instructions or guidance to navigate through the computer-operated telephone system, such as to obtain information of interested like an account balance or to reach a particular individual, such as a customer service representative. IVR systems may be used to create self-service solutions for banking payments, retail orders, utilities, travel information, weather information, or virtually any other service.

To help make IVR systems operate in a user-friendly manner, an example IVR system may be controlled by ASR software. ASR software may allow a user to speak menu options or selections without the cumbersome process of interacting with a telephone keypad. However, because IVR options tend to be short, such as a word or two, or a individual's names, generic ASR software may be limited in its ability to understand commands from a user. In general, ASR software may operate more accurately over longer utterances because additional contextual information can be used to resolve ambiguities when multiple candidates are available for a particular utterance. Thus, in the IVR scenario, particular when a user is speaking a name, conventional ASR systems may not perform with a high level of accuracy, which may lead to user frustration.

Certain aspects and examples of the present disclosure relate to ASR software that provide improved performance in ASR in IVR systems. One example provides an ASR model that combines a trained weighted state transducer (WFSTs) with an attention decoder to efficiently identify candidate names or commands and settle on a result with a high degree of accuracy. In particular, by using a WFST, an ASR system may be specifically configured to listen for a wide range of commands from a user. In combination with the WFST, the model of the ASR system may allow for greater certainty in identifying a correct command.

A WFST includes multiple states (or nodes) and a set of allowed transitions (or edges) between the different states. Generally, a WFST is configured to receive an input and generate an output by progressing through the states according to the allowed transitions and based on the input data. In the case of ASR, a WFST may be configured to generate particular words or phrases and, based on the received audio input, the WEST can provide an indication of how closely the received audio input matches with valid paths through the WFST. Thus, a WFST configured with a valid path for the word “dog” may provide a low score when provided the word “hello” as input, but a high score when audio of the word “dog” is input. By employing a WEST with multiple paths corresponding to valid command within the IVR, the paths of the WEST can each be executed for a received spoken input. Based on traversing the paths, one or more candidate commands or names may be identified.

The candidate commands or names may then be provided to the attention decoder within the ASR model along with the recorded user audio to determine the most likely utterance from the user. In this example, the attention model is implemented by an artificial neural network and outputs an identified spoken word or phrase.

Commands or names (collectively referred to as “commands”) may be identified by submitting audio of spoken language to the ASR system. Each valid command available for the IVR system may have a corresponding path within the WFST. Recognizing a command may involve submitting the audio to the encoder of the ASR system and obtaining a result indicating the likelihood that the WEST path is a match for the input audio. Because these commands or names may be short in duration, an ASR system can use the WEST to quickly identify specific commands or names from a large library of commands or names without the ASR model requiring a prohibitive amount of computing resources.

The best candidate outputs from the WFST, such as those satisfying a predetermined score threshold, may be submitted to an attention-based decoder. The attention-based decoder may receive the inputted audio and the output of the n-best candidates and select a best result from the n-best candidates. The best result may correspond with a registered command, or a part of a registered command.

Once the best result is identified, the system can attempt to identify an available command. Because a user of the IVR system may speak only a part of an available name in a directory or an available command, the best result output by the ASR system may not exactly match to a valid name or command. To account for this, a fuzzy matching model may be used, which may analyze the best result against the list of valid commands or names registered with the IVR system. If an available name or command is a sufficiently good match, the IVR system executes the command or calls the identified extension. However, if the best result does not have a satisfactory score with any of the commands from the list of commands, the IVR may request a user resubmit an audio command or try a new audio command.

The illustrative example is given to introduce the reader to the general subject matter discussed herein and the disclosure is not limited to this example. The following sections describe various additional non-limiting examples and examples of ASR used with an IVR system.

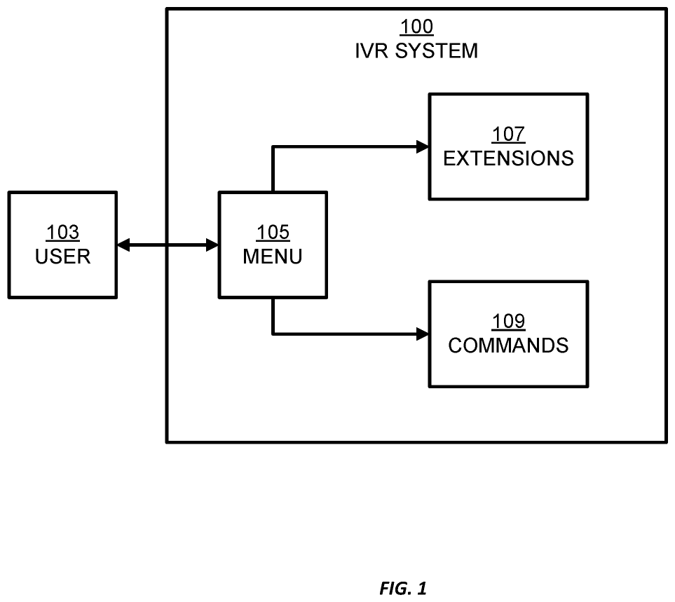

Referring now to FIG. 1. FIG. 1 shows a block diagram of an example IVR system 100. A user 103 may reach extensions 107 or commands 109 by responding to prompts from an audible menu 105 output by the IVR system. The menu 105 may respond to prompts via dual-tone multi-frequency signaling (DTMF) input by a touchtone keypad or by a spoken response that is interpreted with automatic speech recognition (ASR) system.

The IVR system 100 may read to the user 103 a menu 105 of the available extensions 107 or commands 109 that the user 103 may choose from, or the IVR system may more slowly allow the user to navigate through the menu options, such as by first asking whether the user wishes to perform some function or to contact a particular person in an associated organization. Options provided by the menu 105 may include corresponding combinations of keypad inputs that can be entered by the user 103 and the IVR system 100 may also advise the user 103 that they may speak the option they wish to choose.

As discussed above, the menu 105 may guide the user 103 through a series of questions, which may be answerable either by keypad input or by speech, in order to guide the user 103 to one of the appropriate extensions 107 or commands 109. For example, if the user 103 is calling an airline about lost luggage, the menu 105 may ask the user 103 a series of questions to ensure the user 103 is connected to one of the extensions 107 corresponding to a customer service agent specializing in lost luggage. During this process, the ASR aspect of the IVR system 100 may be repeatedly employed for each verbal response provided by the user, which may then allow the user to navigate further into the menu 105 to arrive at the desired command 109 or to contact the appropriate person via their extension 107.

And while this example has been in the context of a user who has called into an IVR system, the IVR system 100 may be deployed for either or both incoming and outgoing telephone calls. For example, the IVR system 100 may interact with the user 103 that has called into the IVR system 100 seeking customer service. In another example, the IVR system 100 may call the user 103, inform them of a weather hazard, and present them with commands 109 through the menu 105 that may allow them to alter preferences related to future weather hazard bulletins, to obtain additional information about the weather bulletin, or to contact someone at the corresponding service to obtain additional information.

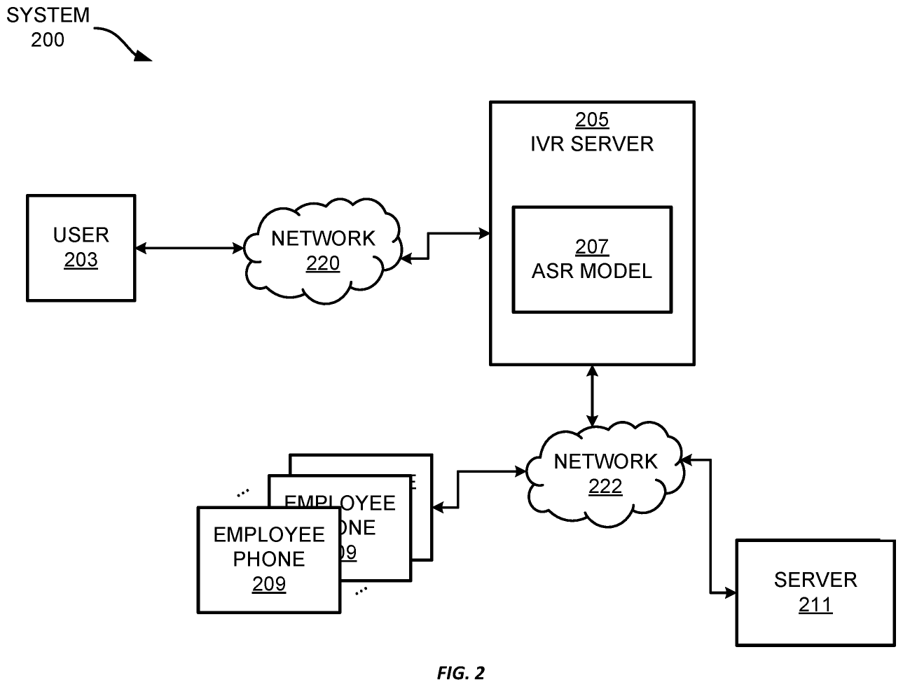

Referring now to FIG. 2. FIG. 2 shows a block diagram of an example system 200 for ASR for IVR systems. The system 200 includes an IVR server 205, multiple employee phone devices 209, and a server 211. In this example, a bank has established an IVR server 205 with ASR functionality to allow its customers or other users to call into its system to access available banking services or contact employees of the bank. And while the present example involves banking services, any other service that can be controlled by IVR commands is also possible. It should be appreciated that while phone devices are depicted, any suitable client device may be employed, such as general computing devices. e.g., smartphones, laptops, desktop computers. In addition, some embodiments may operate in virtual assistants, which may be standalone devices or may be integrated into such general computing devices as software applications, which may operate entirely locally or may interact with a remote server.

A user 203 may interact with the IVR server 205 by calling the bank associated with the IVR via a telephone network 220. Once the user 203 is connected to IVR server 205, the IVR server 205 provides audible prompts to the user to elicit selections from the user, such as by responding to prompts from a menu, similar to the menu 105 of FIG. 1. The user 203 may issue spoken commands that may be recognized by the ASR module 207 of the IVR server 205. In response to commands recognized by the ASR module 207, the IVR server 205 may communicate with the banking server 209 to perform the requested functionality, such as requesting an account balance or opening a new bank account. Alternatively, the user 103 may request to talk with a particular employee at the bank and may speak the employee's name. Upon recognizing the employee's name using the ASM module 207, the IVR server 205 contacts the identified employee's phone 209 and connects the user 203 to the employee.

And while this example is described in a retail banking context, an IVR server 205 may be employed by any type of business, service, or other entity to automate access to available functionality or personnel via an intuitive spoken-word interface.

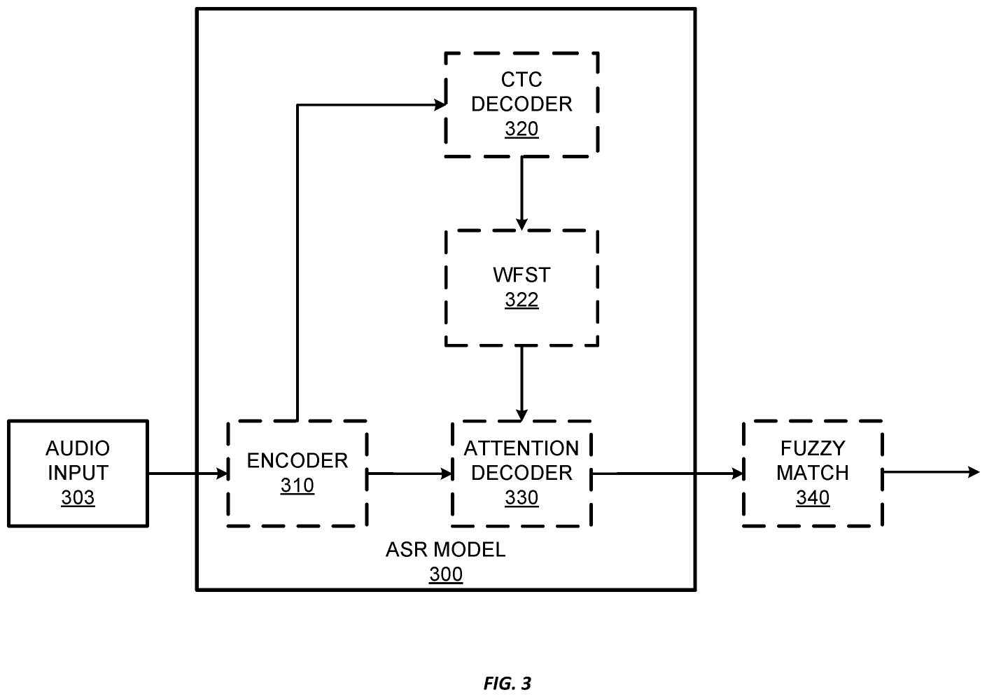

Referring now to FIG. 3. FIG. 3 shows a block diagram of the ASR module 300 for recognizing spoken commands or names, which may collectively be referred to as “commands.” The ASR model 300 receives an audio input 303 that includes speech and provides it to an encoder 310, which encodes the speech into a format suitable for use with both the CTC decoder 320 and the attention model 330. For example, the encoder 310 may perform a fast Fourier transform (“FFT”) to convert the audio data into the frequency domain and transforming it into a set of embedding suitable for input into the CTC and attention decoders.

In this example, the CTC decoder 320 is followed by a WFST 322. The WFST has been trained to generate, and therefore recognize, particular words or phrases, such as commands. For example, each path of the WEST has been trained to recognize one of the available names or commands available within the IVR system. The CTC decoder 320 receives the output of the encoder 310, and outputs candidate commands, most of the time these candidates are not accurate enough to identify a command to execute. Thus, the ASR model employs the WEST 322 as a decoding graph to decode. The search graph of the WEST in this example is composed of three individual components, a T.fst, a L.fst, and a G.fst. The T.fst is a compiled graph of the topo of CTC, the L.fst is a compiled graph of lexicon, and the G.fst is a compiled graph of the language grammar. The output of the CTC decoder 320 feeds into the WFST 322, which then outputs the results.

It should be appreciated that the number of paths within the WFST 321 may be any suitable number to accommodate the available commands or names in the IVR system. Because it takes some time to generate the WFST decoding graph, computing resources may provide a practical limit on the size of the set, such as 10.000 or 50.000 paths: however, given sufficient computing resources, such as a set of cloud servers, much larger sets of paths may be employed, such as to accommodate options in multiple different languages or directories of with large numbers of names. Though, it may be possible in some implementations to share common nodes in some paths, which may decrease the size of the WEST significantly, while resulting in only somewhat degraded performance. It should be appreciated that “substantially in parallel” refers to executing the paths of WFST within a short period of time, such as in real-time or near-real-time (e.g., within 2-3 seconds), to obtain outputs from the WFST. This may be accomplished by initiating execution of each path of the WEST substantially simultaneously, while accommodating situations where the available resources require individual paths of the WEST to execute to completion prior to other individual paths of the WFST. Thus, while execution may not strictly be in parallel, the net effect is that all paths of the WEST are executed in a short period of time to provide a highly-responsive IVR system to the user.

The ASR model 300 also includes an attention decoder as a part of the hybrid model 300. As discussed above, the ASR model 300 has a shared encoder and two different decoders, one is CTC decoder and another is attention decoder. The hybrid model has been trained based on the desired application, such as a dial-by-name application. A training data set of names is generated from data sets of recorded human speech or audio generated from text-to-speech processing by extracting names using named entity recognition (“NER”). The extracted names are then used as the training data set for the attention model. To further enhance the accuracy of the model, such as to identify when uncommon or unrecognized names are spoken, training data from the data set fed to the attention model is infrequently and randomly labeled with an ‘unknown’ tag. In this example, this replacement is performed randomly at a rate of approximately 1 in 10.000 (0.01%).

The attention model 330 is configured to receive the outputs from the WEST 322 as well as the outputs of the encoder 310 and identify a best candidate recognized word or phrase from the audio input 303. In this example, the attention model comprises a transformer network: however, any suitable artificial neural network may be employed. After the attention decoder 330 receives the outputted words or phrases from the WEST 322 and the encoded audio input from the encoder 310, the attention model 330 re-scores each of the outputted words or phrases from the CTC decoder 320 and WEST 322 and identifies the best match as the output. In some cases, the score of the best match may be compared to a second predetermined threshold. If the score satisfies the second threshold, the best match may then be output. Otherwise, the attention model 330 may output an indication that no recognized command was identified.

However, because the best match outputted by the attention decoder 330 may not exactly match a valid command, the system employs fuzzy matching 340 to identify the command that best matches the output from the attention decoder 330. Any suitable fuzzy matching technique may be employed, such as a Levenshtein distance or Hamming distance. The fuzzy matching mechanism 340 then outputs the identified matching command, if one is identified. Alternatively, if the fuzzy matching is not able to identify a matching command, it may output an indication that no match was found and the system may prompt the user re-state the command of interest.

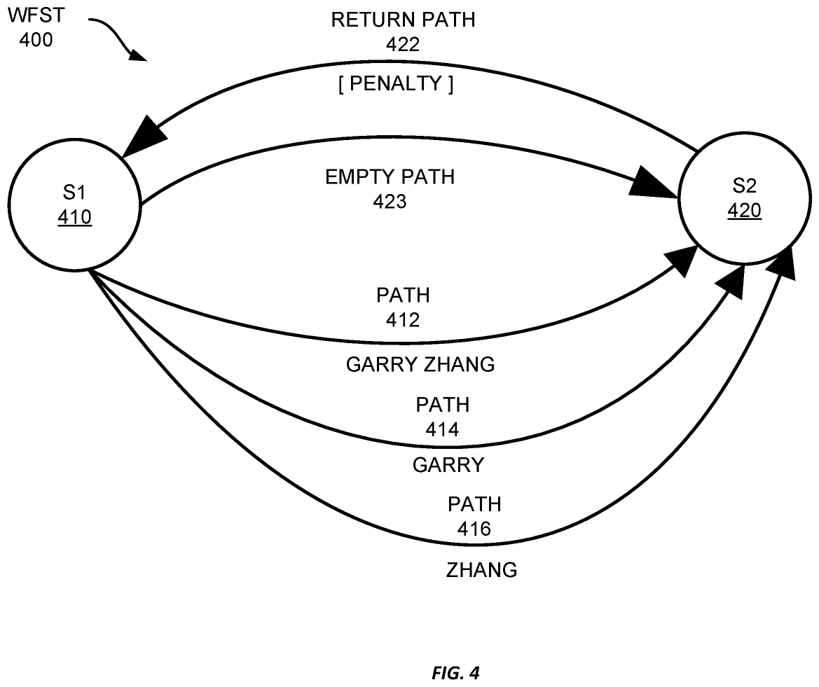

Referring now to FIG. 4. FIG. 4 shows an example WFST 400 for recognizing a command with ASR. The WEST in this example has been trained to generate the spoken commands “Garry Zhang.” “Garry.” and “Zhang.” with each path 412-416 through the FST 400 corresponding to each of these spoken commands. The FST 400 in this example also implements a path corresponding to an unknown or “empty” path that corresponds to unrecognized commands and a path from the end state S2 420 to the start state S1 410, which may be taken as the WFST executes as a part of processing the audio data: however, as indicated in the Figure, the return path has an associated penalty associated with its traversal. Thus, repeated returns to S1 410 will negatively impact the score generated by the FST 400.

In operation, the WEST 400 receives the output from the CTC decoder 320 and determines how closely the received audio data corresponds to one or more paths within the WEST 400 when traversing the available paths 412-416 from S1 410 to S2 420, including traversing the empty path 423 and the return path 422 and applying the corresponding penalty. The impact of the penalty may be tuned based on the system's design. Such a penalty may be used to prevent infinite looping of the FST based on received audio input.

After processing the input data, the WEST 400 may report a score indicating how closely the audio input matches the available paths 412, 414, 416 within the FST 400, by selecting the path with the highest score. Alternatively, the FST may output separate scores for the “Garry Zhang” path 412, the “Garry” path 414, and the “Zhang” path 416. It may also output a score corresponding to the empty path 423, which may indicate that the received input does not correspond to any recognized command.

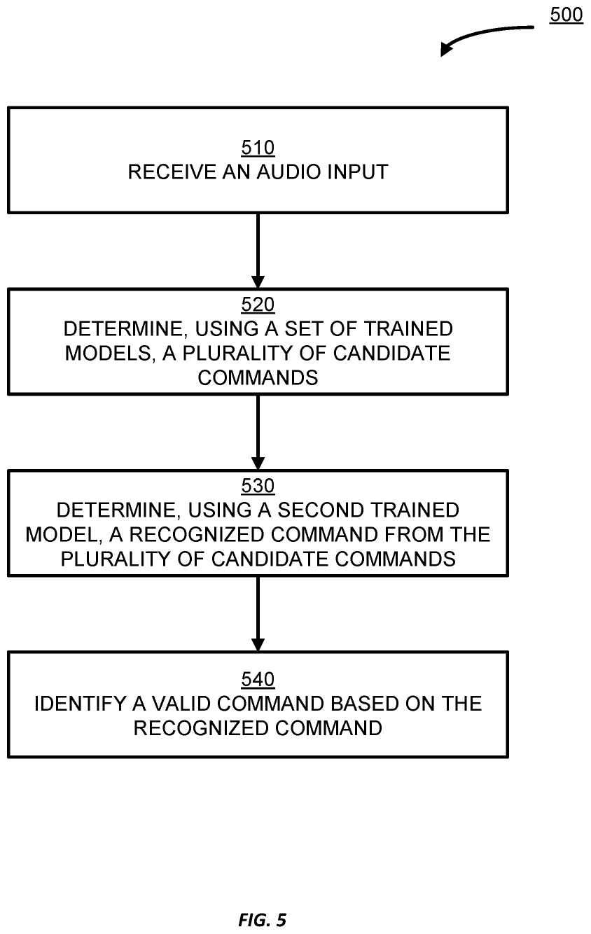

Referring now to FIG. 5. FIG. 5 shows an example method 500 for automated speech recognition for IVR systems. The example method 500 will be described with respect to the system 200 shown in FIG. 2 and the ASR module 300 shown in FIG. 3: however, any suitable system according to this disclosure may be employed.

At block 510, the system 200 receives an audio input 303 from a user. In this example, the user has called a telephone number that has connected the user to the IVR server 205. It should be appreciated, however, that in some examples, the user may interact with the IVR server 205 via an application executing on a client device, such as a voice assistant software that can communicate with the IVR server 205. After the user has connected to the IVR server 205, the IVR server 205 may provide the user with an audio menu that identifies different options available to the user, including options to execute different commands or to contact a person by name. The user may then speak into their telephone to attempt to command the IVR system according to the available options.

When the user speaks into their telephone, the IVR server 205 receives audio input 303 via the telephone connection and converts it into the frequency domain, such as by performing a fast Fourier transform (“FFT”). To do so, the IVR server 205 may first receive and record the audio input 303 before using the FFT. Alternatively, the IVR server 205 may instead convert samples of the audio input 303 in real-time as the audio input 303 is received. The frequency information may then be provided to the encoder 310, or the encoder 310 itself may perform the FFT operations. Alternatively, some examples may operate on the time-domain audio data rather than converting it into the frequency domain.

At block 520, the system 200 determines using a trained model a plurality of candidate commands. In this example, the system 200 employs the ASR model 300 to determine the plurality of candidate commands by submitting the encoder output 310 to a CTC decoder 320, which is followed by a WFST 322, as discussed above with respect to FIG. 3.

The WEST determines scores for the various paths defined within the WEST and outputs one or more scores corresponding to paths having a score that satisfies a predefined threshold. Thus, each output that satisfies the threshold may be a candidate command.

At block 530, the system determines, using a second trained model, a recognized command from the plurality of candidate commands. As discussed above with respect to FIG. 3, the second trained model in the ASR model 300 is the attention decoder 330, which is a trained transformer network that includes an attention mechanism. The ASR model 300 provides the encoder 310 output to the attention model 330 as well as the outputs from the WEST 322, which includes the set of candidate commands. The attention decoder 330 then re-scores each of the candidate commands to generate a final score for each candidate command. The attention decoder 330 then identifies the candidate command with the highest score as the recognized command.

At block 540, the system identifies a valid command in a set of valid commands based on the recognized command. For example, a user may say “account balance” in response to a voice prompt asking them what function they want to access. The ASR module 300 may process the audio input and output the recognized command as “account balance.” after which the IVR server 205 searches the set of valid commands and identifies the “account balance” command. The IVR server 205 may then communicate with server 211 to initiate the “account balance” functionality for the user.

However, in some cases, the recognized command may not exactly match one of the valid commands. For example, as discussed above with respect to FIG. 4, the WFST may have multiple paths, and thus the output from the WEST indicates the scores the paths, resulting in a candidate command such as “balance” or “Zhang.” The attention decoder 330 may then receive the output from the encoder 310 and the WEST 322 to process the candidate commands and determine that “balance” is the recognized command. When searching the set of valid commands, there may be no exact match for “balance.” To address such a scenario, the system employs fuzzy matching 340, which can be used to identify a valid command that does not exactly match the recognized command. Thus, the fuzzy matching functionality 340 may identify the “account balance” command based on the recognized command “balance.” Similarly, when searching for a name, the fuzzy match functionality 340 may identify the entry for “Garry Zhang” based on the recognized command “Zhang.”

After identifying a valid command, the IVR server 205 may communicate with the server 211 to initiate a corresponding function, such as by obtaining the user's account balance, or if the IVR system provides a dial-by-name directory, the IVR server 205 may dial Garry Zhang's telephone number and transfer the user.

In some cases, however, the IVR system 205 may not be able to identify a valid command. For example no candidate commands may be identified because no scores from the WEST 322 satisfied the predetermined threshold. Alternatively, the attention decoder 330 may not generate a recognized command that satisfies a second threshold. Or no valid command may be identified within the set of valid commands. In such cases, the IVR server 205 may prompt the user to speak the command again.

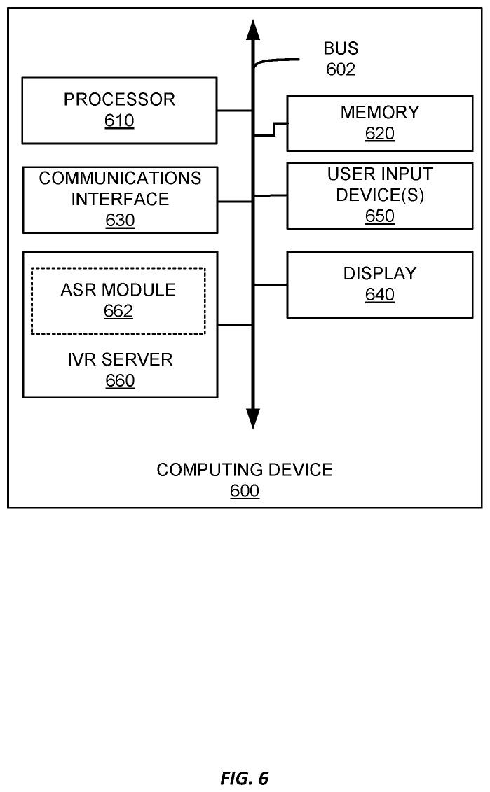

Referring now to FIG. 6. FIG. 6 shows an example computing device 600 suitable for use in example systems or methods for automatic speech recognition for IVR systems according to this disclosure. The example computing device 600 includes a processor 610 which is in communication with the memory 620 and other components of the computing device 600 using one or more communications buses 602. The processor 610 is configured to execute processor-executable instructions stored in the memory 620 to perform one or more methods for automatic speech recognition for IVR systems according to different examples, such as part or all of the example methods described above with respect to FIG. 6. The computing device 600, in this example, also includes one or more user input devices 650, such as a keyboard, mouse, touchscreen, microphone, etc., to accept user input. The computing device 600 also includes a display 640 to provide visual output to a user.

In addition, the computing device 600 includes an IVR server 660 with its ASR module 662. The IVR server 660 and ASR module 662 provide the functionality as discussed above with respect to FIGS. 1-5 to provide automatic speech recognition for IVR systems according to this disclosure.

The computing device 600 also includes a communications interface 640. In some examples, the communications interface 630 may enable communications using one or more networks, including a local area network (“LAN”); wide area network (“WAN”), such as the Internet: metropolitan area network (“MAN”): point-to-point or peer-to-peer connection: etc. Communication with other devices may be accomplished using any suitable networking protocol. For example, one suitable networking protocol may include the Internet Protocol (“IP”). Transmission Control Protocol (“TCP”). User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as conducted, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk. CD-ROM, magnetic disk, memory chip. ROM, RAM, ASIC, configured processor, all optical media, all magnetic tape, or other magnetic media, or any other medium from which a computer processor can read. The processor, and the processing, described may be in one or more structures, and may be dispersed through one or more structures. The processor may comprise code to conduct methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation.” or “in an implementation.” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words. A or B or C includes any or all of the following alternative combinations as appropriate for a particular usage: A alone: B alone: C alone; A and B only: A and C only: Band C only; and A and B and C.

What is claimed is:

1. A method comprising:
receiving an audio input from a user;
determining, using a first trained model, a plurality of candidate commands;
determining, using a second trained model, a recognized command from the plurality of candidate commands; and
identifying a corresponding valid command in a set of valid commands based on the recognized command.

2. The method of claim 1, wherein determining the plurality of candidate commands comprises:
executing available paths within the first trained models;
obtaining scores from the available paths;
comparing the scores to a predetermined threshold; and
determining the plurality of candidate commands based on the scores satisfying the predetermined threshold.

3. The method of claim 1, wherein the first trained model comprises a weighted finite state transducer (“WFST”).

4. The method of claim 3, wherein determining the plurality of candidate commands comprises executing available paths in the WEST substantially in parallel.

5. The method of claim 1, wherein the second trained model comprises an attention-based decoder.

6. The method of claim 1, wherein identifying the corresponding valid command comprises performing fuzzy matching using the recognized command and the set of valid commands.

7. The method of claim 1, further comprising executing the corresponding valid command.

8. A system comprising:
a non-transitory computer-readable medium; and
one or more processors communicatively coupled to the non-transitory computer-readable medium, the one or more processors configured to execute instructions stored in the non-transitory computer-readable medium to:
receive an audio input;
determine, using a first trained model, a plurality of candidate commands;
determine, using a second trained model, a recognized command from the plurality of candidate commands; and
identify a corresponding valid command in a set of valid commands based on the recognized command.

9. The system of claim 8, wherein the one or more processors are configured to execute further instructions stored in the non-transitory computer-readable medium to:
execute available paths within the first trained models;
obtain scores from the available paths;
compare the scores to a predetermined threshold; and
determine the plurality of candidate commands based on the scores satisfying the predetermined threshold.

10. The system of claim 8, wherein the first trained model comprises a weighted finite state transducer (“WEST”).

11. The system of claim 10, wherein the one or more processors are configured to execute further instructions stored in the non-transitory computer-readable medium to execute available paths in the WEST substantially in parallel.

12. The system of claim 8, wherein the second trained model comprises an attention-based decoder.

13. The system of claim 8, wherein the one or more processors are configured to execute further instructions stored in the non-transitory computer-readable medium to perform fuzzy matching using the recognized command and the set of valid commands to identify the corresponding valid command.

14. The system of claim 8, wherein the one or more processors are configured to execute further instructions stored in the non-transitory computer-readable medium to execute the corresponding valid command.

15. A non-transitory computer-readable medium comprising processor-executable instructions configured to cause one or more processors to:
receive an audio input;
determine, using a first trained model, a plurality of candidate commands;
determine, using a second trained model, a recognized command from the plurality of candidate commands; and
identify a corresponding valid command in a set of valid commands based on the recognized command.

16. The non-transitory computer-readable medium of claim 15, further comprising processor-executable instructions configured to cause the one or more processors to:
execute available paths within the first trained models;
obtain scores from the available paths;
compare the scores to a predetermined threshold; and
determine the plurality of candidate commands based on the scores satisfying the predetermined threshold.

17. The non-transitory computer-readable medium of claim 15, wherein the first trained model comprises a weighted finite state transducer (“WEST”).

18. The non-transitory computer-readable medium of claim 17, further comprising processor-executable instructions configured to cause the one or more processors to execute available paths in the WEST substantially in parallel.

19. The non-transitory computer-readable medium of claim 15, wherein the second trained model comprises an artificial neural network including an attention mechanism.

20. The non-transitory computer-readable medium of claim 15, further comprising processor-executable instructions configured to cause the one or more processors to perform fuzzy matching using the recognized command and the set of valid commands to identify the corresponding valid command.
